(19) United States
(12) Patent Application Publication
(10) Pub. No.: US 2010/0055426 A1
(43) Pub. Date: Mar. 4, 2010

(54) MULTILAYER ADHESIVE TAPE

(75) Inventors: Petra Yun, Hamburg (DE); Ulrich Otten, Hamburg (DE)

Correspondence Address: Hildebrand, Christa;Norris McLaughlin & Marcus PA, 875 Third Avenue, 8th Floor, New York, NY, 10022, US

(73) Assignee: TESA SE, HAMBURG (DE)

(21) Appl. No.: 12/516,848

(22) PCT Filed: Dec. 5, 2007
(86) PCT No.: PCT/EP2007/063362

§ 371 Date: Jul. 9, 2009

(30) Foreign Application Priority Data
Dec. 21, 2006 (DE) 10 2006 061 812.2

(51) Int. Cl. C09J 7/02; B29C 47/06; B32B 7/02; B32B 27/08; B32B 27/32

(52) U.S. Cl. 428/212; 264/173.16

(57) ABSTRACT

Transparent tape with a backing which has been stretched predominantly in one direction, wherein the backing has at least one basic layer which is provided with at least one outer, impact resistant layer which is more impact resistant than the basic layer, the basic layer is provided on the side opposite the layer with an adhesive layer based on an aqueous acrylate dispersion, and the outer layer does not have a release coating on the free side.

The present invention relates to a multi-ply adhesive tape that can be used in particular as a tear-open strip.

Tear-open strips are known and serve in various forms as an opening aid on the one hand for cigarette packs, confectionery packs and similar packs which are wrapped with a film, and on the other hand for cardboard packaging such as detergent packs for instance. In such applications the tear-open strip is affixed to the pack in such a way that, for the purpose of opening, the tear-open strip is pulled and hence the wrapping film or cardboard box is destroyed at the desired site.

Traditionally in use are tear-open strips provided on one side with a hotmelt-based adhesive. These are described in U.S. Pat. No. 3,187,982 A, U.S. Pat. No. 3,311,032 A or CA 749 198 A, for example.

Also in use is a tear-open strip which is self-adhesive. For this purpose a monoaxially oriented carrier film is used which is equipped with a self-adhesive layer on one side and a silicone release layer on the other side. Optionally there is printing beneath one of the two layers. Constructions of this or similar kind are known for the production of pressure-sensitive adhesive tapes from, for example, DE 21 04 817 A, U.S. Pat. No. 3,088,848 A, U.S. Pat. No. 3,482,683 A or U.S. Pat. No. 2,956,904 A. Not disclosed in those specifications is the use of such film constructions for self-adhesive tear-open strips. The use of self-adhesive tapes of this kind as tear-open strips is mentioned, however, in the February 1973 issue of the journal “Packaging Review”, page 57.

One specific embodiment of these self-adhesive tear-open strips is described by DE 43 38 524 A1. Disclosed therein is a self-adhesive tear-open strip composed of a carrier film, a release layer, a layer of adhesive facing away from the release layer, and, if desired, printing beneath the layer of adhesive or the release layer. The strip is characterized in that the carrier film is composed of an oriented film, in that the release layer and layer of adhesive are applied from aqueous solution, emulsion or dispersion, and in that release layer, printing ink and layer of adhesive are applied to a film which is broader by a multiple than the tear-open strip in one operation on a machine.

Customary for use as an opening aid for film packs are at least monoaxially, preferably biaxially, oriented and at least one-layer carrier films which are 15 to 60 μm thick.

Self-adhesive or heat-activable tear-open strips comprising polypropylene film which has been oriented in longitudinal direction have long been in use for the tear-opening of cardboard packaging. They are available in film thicknesses from 50 to 140 μm. Film thicknesses greater than 85 μm find use in the opening of particularly heavy cardboard packaging. More customary are tear-open strips in thicknesses between 60 and 90 μm.

Tear-open strips which are based on a monoaxially oriented polypropylene carrier frequently use, for the carrier, a specific polymer blend which has been optimized in its tear-opening performance, and results in longitudinal-direction tensile strengths of 230 to 330 N/mm².

These polypropylene tear-open strips at preferably 60 to 65 μm exhibit flawless tear-open performance on all corrugated cardboard packaging, including micro-corrugated cardboard. This applies irrespective of whether tearing is carried out exactly in the direction of the adhered strip.

“Exactly in the direction of the adhered strip” means that, in the operation of tear-opening, the tear-open strip is guided in such a way that the pulling direction never deviates from the direction which is mandated by the tear-open strip bonded to the rear of the carton and which is also visible from the front of the carton as a tear-open joint during the tear-open operation. Only in that case is the distribution of forces in the tear-open strip symmetrical during the tear-open operation, and the load on both edges uniform. In actual practice this ideal tear-open direction is usually not observed. Deviations from this direction of up to about 30° must be expected.

A trend within the market for tear-open strips is the deviation from the film formula that has been optimized for tear-open performance. A reduced tear-open performance is in this case accepted willingly in order, in contrast, to obtain improved machine compatibility of the tear-open strip during its application.

By way of example it is possible to reduce the impact modifiers to below the amount that is advisable for optimum tear-open performance, up to the point of their complete omission.

Heavy-duty solid-cardboard grades with about 1000 g/m² can be torn open faultlessly only in the optimum tear-open direction. In the event of deviation from this direction, the unsymmetrical load on the strip may result in tears during the tear-open operation that start from the more heavily loaded edge of the strip. The frequency of the tears is influenced, for example, by inhomogeneities in the film, by microindentations in the cut edges of the film strips, by wood particles or particularly solidified particles in the cardboard, and similar phenomena. Also possessing an influence is the tear-opening speed.

For the packaging of laundry detergents, use is made to a relatively large extent of solid cardboards with a basis weight of between 450 and 600 g/m², which in some circumstances have a wax-impregnated interlayer, but in any case are provided with a laminated-on top layer of high-gloss cast-coated Chromolux papers. Tearing open these cardboards with the polypropylene tear-open strips can be achieved only with a similarly poor result as for the abovementioned 1000 g/m² solid boards.

Known from EP 0 269 967 A1 is a tear-open strip having a carrier oriented in predominantly one direction and being provided with an adhesive layer, the carrier being composed of at least one base layer which is provided with at least one tough layer which is tougher than the base layer.

Particular preference is given to a tear-open strip having a carrier which is oriented in predominantly one direction and which is provided with an adhesive layer, the carrier being composed of at least one base layer comprising a polypropylene-olefin copolymer and/or a polypropylene/impact modifier mixture, the base layer being provided with at least one tough, polypropylene-containing layer which comprises an impact modifier and is tougher than the base layer.

In the description of single-sidedly adhesive tear-open strips, the prior art applies a release to the side facing away from the adhesive: an example is the aforementioned DE 43 38 524 A1.

For masking films and surface protection films, adhesive tapes are known which have a carrier composed wholly or partly of PE (polyethylene) and an adhesive based on an acrylate dispersion.

Primarily for reasons of cost, these adhesive tapes do not have a release layer on the open carrier side.

For CST (carton sealing tapes), furthermore, the combination of acrylate dispersion adhesive together with a polypropylene carrier, more precisely with BOPP, is known, again without the carrier having a release coating. The unwind behavior of such tapes, however, is difficult and usually loud.

For tear-open strips this is not an appropriate solution.

In the case of tear-open strips based on polypropylene it is preferred to use TPP (corresponding to monoaxially oriented polypropylene (MOPP)), since the stretch must be low even under high tensile load.

High tensile loads come about, on the one hand, in the ultimate application, when the tear-open strip is pulled when the pack is open, through the board or the carton and/or the film, and is intended to break these materials apart reliably. Secondly they also come about when the tear-open strip is applied to the packaging, since it is frequently applied at speeds of more than 150 m/min. Particularly at the start, i.e., when the tear-open strip is placed onto—for example—the board, the roll, up to about 15 kg in weight, to which the tear-open strip is typically converted is accelerated suddenly and violently. Even in ongoing operation, tensile stresses of more than 8 N are often acting on the tear-open strip. This rules out the use of unoriented or even biaxially oriented polypropylene.

If TPP without a release is used, then unwinding, i.e., the separation of adhesive and carrier, is accompanied by splicing of the carrier, which means that some of the fibers stretched and oriented in the longitudinal direction are extracted from the surface of the carrier. This may adversely affect the converting operation if the coated film web, which is very much wider than the tear-open strip, is slit into individual tear-open strips and for that purpose is unwound from the jumbo roll. The fibers projecting from the surface of the carrier themselves hinder the operation, or else there may be tearing of the carrier web as a whole. Moreover, similar problems may occur in the course of application to the packaging when the tear-open strip is being unwound.

The invention is based on the object of providing an adhesive tape which is suitable in particular as a tear-open strip, and which thus possesses an oriented, preferably longitudinally oriented, carrier film, which, while being as thin as possible, ensures optimum tear-opening in its use as a tear-open strip, even when the tear-open direction deviates from the direction of the bonded adhesive tape.

This object is achieved by means of an adhesive tape as specified in the main claim. The dependent claims provide advantageous developments of the adhesive tape and also preferred fields of application of the adhesive tape of the invention.

The invention accordingly provides an adhesive tape having a carrier oriented in predominantly one direction, the carrier having at least one base layer which is provided with at least one external, impact-resistant layer which is more impact-resistant than the base layer, the base layer on the side opposite the external layer being provided with an adhesive layer based on an aqueous acrylate dispersion, and the external layer having no release coating on the free side.

As well as the advantages of this second layer in terms of its impact strength properties, which apply without reduction in the case as well of a tear-open strip in accordance with the invention described here, this layer fulfills the further function which is important for the invention, namely the possible omission of a release layer.

It is preferred for the carrier to be composed of a polypropylene-olefin copolymer and/or a polypropylene.

The base layer or base layers are preferably composed predominantly, preferably to an extent of at least 70% by weight, of a polypropylene having a high isotactic fraction, preferably an at least 70% isotactic fraction. Random or else block copolymers of propylene and olefins are used with preference. Particular preference is given to using propylene-ethylene copolymers which contain up to 20% by weight of ethylene in copolymerized form.

The base layer or base layers may be composed of 100% of propylene-olefin copolymers or may contain, admixed to said copolymers, preferably up to 25% by weight of an impact modifier which is suitable for improving the impact strength, of polypropylene oriented in the web direction, in the direction perpendicular thereto. Preferred modifiers are low-density polyethylene, especially linear low-density PE (LLDPE), thermoplastic rubbers such as butadiene-styrene copolymers (SBS) or isoprene-styrene copolymers (SIS), in particular their block copolymers in each case, or ethylene-vinyl acetate copolymers (EVA).

The base layers may also be composed of polypropylene homopolymer to which, in that case, an impact modifier has been admixed, preferably at least 10% by weight, not more than preferably 30% by weight.

Mixtures of the stated propylene-olefin copolymers with the propylene homopolymer can be used as well, in which case the fraction of impact modifiers may go down in accordance with the increasing copolymer fraction.

The impact modifiers are preferably added individually. Mixtures of the stated impact modifiers, however, can also be used.

The base layers preferably contain 75% to 100% by weight of copolymer and 25% to 0% by weight of LLDPE, or 80% to 100% by weight of copolymer with 20% to 0% by weight of thermoplastic rubber, more particularly SBS, or 75% to 100% by weight of copolymer and 25% to 0% by weight of EVA, but preferably 80% to 95% by weight of copolymer and 5% to 20% by weight of LLDPE, or 85% to 95% by weight of copolymer and 5% to 15% by weight of thermoplastic rubber, more particularly SBS, or 85% to 95% by weight of copolymer and 5% to 15% by weight of EVA.

For the outer layer of the tear-open strip that faces away from the adhesive and is arranged on the base layer or base layers, mixtures of material are used that preferably contain significantly higher fractions of an impact modifier than the base layer and hence at the same time ensure a higher impact strength and application-compatible unwind behavior of this outer layer. It is preferred to use up to 50% by weight of a propylene-olefin copolymer or of a propylene homopolymer, as indicated for the base film. The fraction of the ethylene polymer can be 50% to 100% by weight, but preferably 60% to 80% by weight.

It is preferred to use the same individual impact modifier in each case in base layers and in the tough layer. The use of different individual impact modifiers, or of identical or different mixtures of the impact modifiers, is also possible, however.

Suitable polyethylenes include LDPEs, metallocene PEs, but especially linear low-density polyethylenes (LLDPEs). The linear low-density polyethylene (LLDPE) used with preference is a special ethylene copolymer having a density of 0.910 to 0.935 g/cm³ which has been copolymerized using an olefin containing at least three carbon atoms (see L. Schwiegk: “LLDPE—ein neues Polyäthylen” [LLDPE—a new polyethylene], Plastver-arbeiter vol. 33 1982, no. 9, pages 1035 to 1037).

The carrier is obtained by extrusion and monoaxial orientation, preferably by coextrusion of the layers to give a coextruded primary film and subsequent orientation of the primary film in at least one direction, using customary methods that are general knowledge. Orientation takes place preferably in the longitudinal direction.

The draw ratio in the orientation of the coextruded primary film in the longitudinal direction is preferably 1:5 to 1:9, more preferably 1:6.5 to 1:7.5. The draw ratio indicates the formation, from a section of the film with a length, for example, of 1 m, of a section of the oriented film with a length of 6 m (draw ratio 1:6). The expression “web direction” is also known in other formulations, examples being as follows: longitudinal direction, machine running direction. Orientation takes place, without a substantial decrease in the width of the primary film, solely at the expense of the thickness of the film.

The thickness of the oriented carrier can be 50 to 140 μm, preferably 60 to 120 μm, more preferably 65 to 90 μm. The fraction of the base layer or base layers together is 50% to 95% or, for a carrier optimized for tear-open performance, preferably 65% to 75%, of the total thickness of the carrier. For economic reasons it may be desired to reduce the thickness of the tough layer to the minimum thickness that is necessary for the unwind properties. In this case the fraction of the load-bearing base layer may be increased to up to 95%.

In accordance with the invention it is possible for two or more tough layers to be placed on both surfaces of the base layer and above one another.

To produce the adhesive tape, an adhesive based on an aqueous acrylate dispersion is applied to one side of the carrier. The anchorage of the adhesive can be enhanced by pretreating the surface by methods of the kind customarily employed for polyolefin surfaces, such as with corona pretreatment or flame pretreatment, for example. Special anchoring layers may likewise be utilized.

Aqueous acrylate dispersions are known and are used in large quantities not only for adhesives of adhesive tapes but also for adhesives of labels. The acrylate dispersions comprise particles of acrylate polymers which are in disperse distribution in the aqueous phase of the dispersion. Acrylate dispersions are prepared in an aqueous medium by polymerization of suitable monomers. The preparation may take place either as a batch operation or by metered addition of one or more components during the polymerization. In the case of batch operation, all of the components required are introduced simultaneously.

The properties of the acrylate dispersions and of the corresponding adhesives are determined primarily by the selection of the monomers and the molecular weight attained. The major monomers are n-butyl acrylate, 2-ethylhexyl acrylate and acrylic acid. Suitable monomer units are described in “Acrylic Adhesives”, Donatas Satas, in Handbook of Pressure Sensitive Adhesive Technology, Second Edition, edited by Donatas Satas, Van Nostrand Reinhold New York, pages 396 to 456.

The acrylate dispersions preferred in accordance with the invention contain more particularly
0% to 10% by weight of acrylic acid units
0% to 100% by weight of n-butyl acrylate units
0% to 100% by weight of 2-ethylhexyl acrylate units.

One preferred version uses acrylate dispersions with 0.5% to 3% by weight of acrylic acid units. Another preferred version uses acrylate dispersions with 0.5% to 3% by weight of acrylic acid units and 99.5% to 90% by weight, more preferably 99.5% to 96% by weight, of n-butyl acrylate units. A further example of acrylate dispersions of the invention are acrylate dispersions with 80% to 90% by weight of 2-ethylhexyl acrylate units and 8% to 20% by weight of n-butyl acrylate units.

The acrylate dispersions may additionally comprise further monomer units through which it is possible to exert control on, for example, the glass transition temperature and the crosslinkability. Examples are methyl acrylate, ethyl acrylate, methyl ethyl acrylate, maleic anhydride, acrylamide, glycidyl methacrylate, isopropyl acrylate, n-propyl acrylate, isobutyl acrylate, n-octyl acrylate, and the corresponding methacrylates of these acrylates. The acrylate dispersions typically contain 0% to 10% by weight of these additional monomer units; either exclusively one additional monomer unit or mixtures thereof are used.

The solids content of the acrylate dispersions is more particularly between 40% and 70% by weight, preferably between 45% and 65% by weight.

Mention may be made, by way of example, of the Primal PS 83d or Primal PS 90 acrylate dispersions from Rohm & Haas that can be used in accordance with the invention.

The dispersion may if desired comprise further additions such as, for example, fillers or crosslinking agents. Suitable crosslinking agents may be epoxy resins, amine derivatives such as hexamethoxymethyl melamine, for example, and/or condensation products of an amine, for example melamine, urea with an aldehyde, for example formaldehyde.

The adhesives used for producing the adhesive tapes of the invention may comprise further components if these components are selected in such a way that they do not impair the properties (particularly grab and water insensitivity). Examples are resins, plasticizers, dyes, defoamers and thickeners and also further adjuvants for setting the desired rheological behavior. Modifications of acrylate dispersions are known and are described in, for example, “Modification of Acrylic Dispersions”, Alexander Zettl, in Handbook of Pressure Sensitive Adhesive Technology, Second Edition, edited by Donatas Satas, Van Nostrand Reinhold New York, pages 457 to 493.

The adhesive can be optimized for higher shear strength through use of crosslinkers. The selection and proportion of the crosslinkers are known to the skilled worker and can be specified as a result of corresponding tests. Crosslinkers for acrylate dispersions are known in principle and described for example in “Acrylic Adhesives”, Donatas Satas, in Handbook of Pressure Sensitive Adhesive Technology, Second Edition, edited by Donatas Satas, Van Nostrand Reinhold New York, pages 411 to 419.

Isocyanate-based crosslinkers are suitable in principle, but are not preferred on account of the limited pot lives and the increased occupational hygiene requirement. An example of an isocyanate-based crosslinker is Basonat F DS 3425 X (BASF).

Isocyanate-free crosslinkers are preferred, examples being crosslinkers based on salts of polyfunctional metals. These are known in principle and described for example in U.S. Pat. No. 3,740,366 A, U.S. Pat. No. 3,900,610 A, U.S. Pat. No. 3,770,780 A, and U.S. Pat. No. 3,790,553 A. Particularly suitable crosslinkers are those based on zinc complexes which are able to form covalent and/or complex like bonds with carboxyl groups.

The invention also provides the method of producing the adhesive tape of the invention.

The adhesive tapes can be produced by known methods. An overview of typical production methods is found in, for example, “Coating Equipment”, Donatas Satas, in Handbook of Pressure Sensitive Adhesive Technology, Second Edition, edited by Donatas Satas, Van Nostrand Reinhold New York, pages 767 to 808. The known methods of drying and slitting the adhesive tapes are likewise found in the Handbook of Pressure Sensitive Adhesives Technology, pages 809 to 874.

The coating of the carrier with dispersion-based adhesive takes place preferably using wire doctor systems which are set up in such a way that the desired coatweight is obtained. The subsequent drying of the coated film takes place in particular in a drying tunnel which is operated with hot air. Additional drying by means of infrared lamps is also possible in principle.

The rolls of adhesive tape should as far as possible be wound up with uniform tension and uniform pressure applied. The optimization of winding is dependent on the apparatus used and is known to the skilled worker.

On account of its properties the adhesive tape can be used to outstanding effect as a tear-open strip.

It is able to effect flawless opening of materials with a high tear-opening resistance, especially cardboard packaging.

The adhesive tape has an economical advantage since it is possible to omit a release.

It is particularly advantageous that a silicone release is done away with.

The silicone commonly used for tear-open strips is sometimes considered critically, and sometimes absence of silicone from products is a requirement per se (as, for example, in the Japanese food sector).

Furthermore, silicone causes problems as a result of silicone transfer. For tear-open strips, on printed boards which have been in contact with the reverse of the tear-open strip in the stack there are occasionally faults in the printed image.

The unwind characteristics are advantageous for application at high speeds (corrugated board lines usually run at >150 min, up to 300 m/min).

Although these characteristics are similar to those of carbamate, the latter is nevertheless subject in principle to the risk of carrier splicing, particularly at high speeds, if the carbamate is not optimally distributed or has blocked after excessively hot storage.

The general expression “adhesive tape” in the sense of this invention encompasses all sheetlike structures such as two-dimensionally extended sheets or sheet sections, tapes with extended length and limited width, tape sections, diecuts, labels and the like.

The adhesive tape of the invention is described below in a preferred embodiment with reference to a number of examples without thereby wishing for the invention to be subject to any restriction whatsoever.

The Melt Flow Ratio (MFR) melt index is given to ISO 1133. For polyethylenes these ratios are usually stated in g/10 min at 190° C. and a weight of 2.16 kg, and for polypropylenes accordingly but at a temperature of 230° C.

All quantities and percentages are by weight. “ppw” denotes parts by weight.

### EXAMPLE 1

A mixture I of 90 ppw of polypropylene copolymer with 3% to 6% by weight of ethylene, melt index (230/2.16) 0.9-0.3 g/10 min, for example, Propathene GSF 113 from ICI, and 10 ppw of an LLDPE with a density of 0.920 g/cm³ containing 1-octene as comonomer, melt index (230/2.16) 3.0+0.5 g/10 min, for example, Stamylex PE 1026 from DSM, is melted and extruded in a relatively high-throughput main extruder. In a second auxiliary extruder of lower throughput, a mixture II of 35 ppw of the above-specified polypropylene copolymer with 65 ppw of the above-specified polyethylene copolymer is likewise melted. The two extruders are coordinated with one another in such a way that a coextruded film with a total thickness of 620 to 650 μm and a width of 1400 mm is extruded through a slot die onto a chill roll. The fraction of the mixture I as a proportion of the overall thickness is 450 to 470 μm, that of mixture II 180 to 200 μm. This primary film is supplied via preheating rolls to a roll orientation mechanism of customary construction, and is subjected to longitudinal orientation in a ratio of 1:7.5 at temperatures from 100 to 135° C. The resulting film has a thickness of 83 to 87 μm and, after edge trimming, a width of 1200 mm. The fraction of mixture I as a proportion of the overall thickness is 60 to 63 μm. The oriented overall film has in the longitudinal direction a tensile force at 10% elongation of 85 N/cm, a breaking force of 180 N/cm, and a breaking elongation of 60%.

A pressure-sensitive adhesive is applied to the foil. Using a wire doctor, a coat which improves the adhesion of the adhesive to the film is first applied, with a coatweight of 0.75 g/m². In the same operation, after this coat has been dried, an adhesive is coated over the corona-pretreated surface of the base layer, with a weight per unit area of 28 g/m². This adhesive is an acrylate dispersion with

| | |
|---|---|
| 82.5% by weight | poly-2-ethylhexyl acrylate |
| 6.2% by weight | methyl methacrylate |
| 5.9% by weight | acrylic acid |
| 5.4% by weight | vinyl acetate. |

After the coating operation, the coated carrier webs are slit to tear-open strips 4 mm wide on specialty slitting machines and are wound up in a customary manner to form jumbo rolls with a length of 35 000 m.

### EXAMPLE 2

In deviation from example 1, but using the same formula of the base layer and coextrusion layer, the thickness of the coextrusion layer is reduced to 5 μm. The resulting overall thickness of the carrier is 68 μm. The oriented overall film has in the longitudinal direction a tensile force at 10% elongation of 70 N/cm, a breaking force of 175 N/cm, and a breaking elongation of 45%.

Using a wire doctor, a coat which improves the adhesion of the adhesive to the film is first applied, with a coatweight of 0.75 g/m². In the same operation, after this coat has been dried, an adhesive is coated over the corona-pretreated surface of the base layer, with a weight per unit area of 30 g/m². This adhesive is an acrylate dispersion with

| | |
|---|---|
| 63% by weight | poly-n-butyl acrylate |
| 25% by weight | poly-2-ethylhexyl acrylate |
| 10% by weight | polymethyl methacrylate |
| 2% by weight | poly-2-hydroxyethyl methacrylate. |

### EXAMPLE 3

A mixture I of 90 ppw of polypropylene copolymer, for example, 7CO6 from Dow, 6.5 ppw of an LLDPE, for example, Dowlex 2032 from Dow, and 3.5 ppw of a color masterbatch is melted and extruded in a relatively high-throughput main extruder. In a second auxiliary extruder of lower throughput, a mixture II of 30 ppw of the above-specified polypropylene copolymer with 67 ppw of the above-specified polyethylene copolymer and also 3 ppw of the color masterbatch is likewise melted.

The two extruders are coordinated in such a way that orientation in a ratio of 1:6.8 gives a film having a thickness of 62 to 65 μm. The fraction of mixture I as a proportion of the overall thickness is 48 to 49 μm; the fraction of mixture II as a proportion of the overall thickness is 14 to 15 μm. The oriented overall film has in the longitudinal direction a tensile force at 10% elongation of 65 N/cm, a breaking force of 145 N/cm, and a breaking elongation of 50%.

Using a wire doctor, a coat which improves the adhesion of the adhesive to the film is first applied, with a coatweight of 0.75 g/m². In the same operation, after this coat has been dried, an adhesive is coated over the corona-pretreated surface of the base layer, with a weight per unit area of 28 g/m². This adhesive is an acrylate dispersion with

| | |
|---|---|
| 98% by weight | n-butyl acrylate |
| 2% by weight | hydroxyethyl acrylate. |

### EXAMPLE 4

A polypropylene copolymer with 3% to 6% by weight of ethylene, melt index (230/2.16) 0.9-0.3 g/10 min, for example, Propathene GSF 113 from ICI, is melted and extruded in a relatively high-throughput main extruder. In a second auxiliary extruder of lower throughput, a mixture II of 35 ppw of the above-specified polypropylene copolymer with 65 ppw of the above-specified polyethylene copolymer is likewise melted and is extruded and coated as shown in example 2. The oriented overall film has in the longitudinal direction a tensile force at 10% elongation of 110 N/cm, a breaking force of 235 N/cm, and a breaking elongation of 35%.

### COUNTEREXAMPLE

A mixture I of 90 ppw of polypropylene copolymer with 3% to 6% by weight of ethylene, melt index (230/2.16) 0.9-0.3 g/10 min, for example, Propathene GSF 113 from ICI, and 10 ppw of an LLDPE with a density of 0.920 g/cm³ containing 1-octene as comonomer, melt index (230/2.16) 3.0+0.5 g/10 min, for example, Stamylex PE 1026 from DSM, is melted and extruded in an extruder. This primary film is supplied via preheating rolls to a roll orientation apparatus of customary construction and is subjected to longitudinal orientation in a ratio of 1:7.5 at temperatures from 100 to 135° C. The resulting film has a thickness of 62 to 64 μm. The oriented film has, in the longitudinal direction, a tensile force at 10% elongation of 70 N/cm, a breaking force of 170 N/cm, and a breaking elongation of 40%.

This double-sidedly corona-pretreated film is furnished on one side with a silicone release and coated on the other side with a pressure-sensitive adhesive, in analogy to example 2.

| | | Force at | Breaking | Breaking | Bond |
|---|---|---|---|---|---|
| | | 10% | force | elongation | strength |
| | Thickness | elongation | longitudinal | longitudinal | to steel |
| | [μm] | [N/cm] | [N/cm] | [%] | [N/cm] |
| Example 1 | 85 | 85 | 180 | 60 | 2.8 |
| Example 2 | 68 | 70 | 175 | 45 | 3.4 |
| Example 3 | 63 | 65 | 145 | 50 | 4.2 |
| Example 4 | 68 | 110 | 235 | 35 | 3.4 |
| Counter- | 63 | 70 | 170 | 40 | 3.4 |
| example | | | | | |

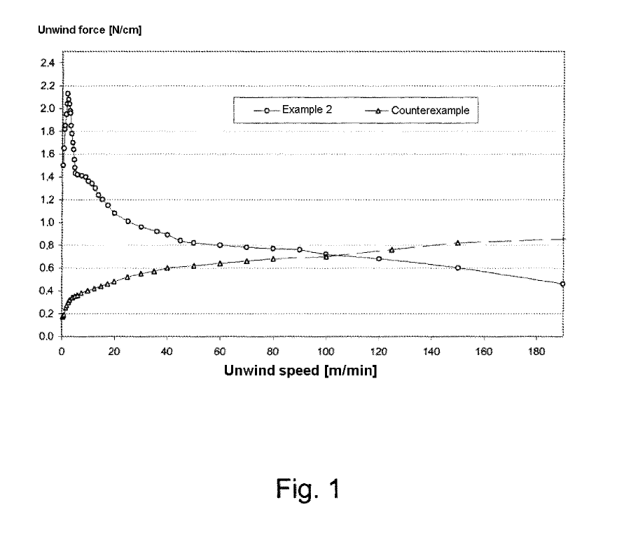

FIG. 1 shows the relationship between the unwind force and the unwind speed, for an adhesive tape according to example 2 and also for adhesive tape according to the counterexample.

1. An adhesive tape comprising
a carrier oriented in predominantly one direction,
the carrier having at least one base layer including at least one external, impact-resistant layer which is more impact-resistant than the base layer, the base layer on the side opposite the layer being provided with an adhesive layer based on an aqueous acrylate dispersion, and the external layer having no release coating on the free side.

2. The adhesive tape of claim 1, wherein the base layer of the carrier is composed of a polypropylene-olefin copolymer and/or a polypropylene.

3. The adhesive tape of claim 1, wherein the base layer is composed of at least about 70% by weight, of a polypropylene having a high isotactic fraction.

4. The adhesive tape of claim 1, the thickness of the at least one base layer is 50% to 95% of the carrier thickness.

5. The adhesive tape of claim 1, wherein the impact-resistant layer and the base layer comprises as impact modifier a linear low-density polyethylene, a thermoplastic rubber and/or an ethylene-vinyl acetate copolymer.

6. The adhesive tape of claim 1, wherein the carrier is composed of a base layer and one impact-resistant layer.

7. The adhesive tape of claim 1, wherein the thickness of the oriented carrier is 50 to 140 μm.

8. (canceled)

9. A method of producing an adhesive tape according to claim 1, comprising the steps of obtaining the carrier by coextrusion of the individual layers and subsequent orientation.

10. The adhesive tape of claim 3, wherein the high isotactic fraction is at least 70% isotactic fraction.

11. The adhesive tape of claim 7, wherein the thickness of the oriented carrier is 60 to 120 μm.

12. The adhesive tape of claim 7, wherein the thickness of the oriented carrier is 65 to 90 μm.
